(19) United States
(12) Patent Application Publication
(10) Pub. No.: US 2026/0032258 A1
(43) Pub. Date: Jan. 29, 2026

(54) Quality- and Energy-aware Resolution Selection for Per-Title Encoding

(71) Applicant: Bitmovin GmbH, Klagenfurt am Wörthersee (AT)

(72) Inventors: Mohammad Ghasempour, Klagenfurt am Wörthersee (AT); Hadi Amirpour, Klagenfurt am Wörthersee (AT); Christian Timmerer, Klagenfurt am Wörthersee (AT)

(73) Assignee: Bitmovin GmbH, Klagenfurt am Wörthersee (AT)

(21) Appl. No.: 19/277,549

(22) Filed: Jul. 23, 2025

Related U.S. Application Data
(60) Provisional application No. 63/674,885, filed on Jul. 24, 2024.

(51) Int. Cl. H04N 19/156; H04N 19/154; H04N 19/31; H04N 19/33

(52) U.S. Cl. CPC H04N 19/156; H04N 19/154; H04N 19/31; H04N 19/33

(57) ABSTRACT

Techniques relating to energy-aware resolution selection and bitrate ladder construction are disclosed. A method for energy-aware bitrate ladder construction includes downscaling an input video, encoding the downscaled versions using a set of input bitrates, decoding the video representations, to generate downscaled raw videos, upscaling the downscaled raw videos to the original resolution and framerate, evaluating a quality of the processed video as compared to the original input, thereby generating a quality value for the processed video, and generating an energy-aware bitrate ladder using the quality value, an energy consumption value, and a tunable threshold value. A method for quality- and energy-aware resolution selection includes performing feature engineering to select a most relevant feature for a video, generating a candidate list of representations, selecting a representation from the candidate list of representations using an energy consumption lookup table and a tunable parameter, and generating a quality- and energy-aware bitrate ladder using the selected representation.

### CROSS-REFERENCE TO RELATED APPLICATIONS

This application claims the benefit of U.S. Provisional Patent Application No. 63/674,885 entitled “Energy-aware Spatial and Temporal Resolution Selection for Per-Title Encoding,” filed Jul. 24, 2024, the contents of which are hereby incorporated by reference in their entirety.

### BACKGROUND OF INVENTION

With the ubiquity of video streaming in the digital age, the efficient delivery of high-quality video content is of paramount concern. As more and more aspects of our lives migrate to online platforms, from entertainment and education to business and communication, the demand for seamless, high-resolution video streaming experiences continues to surge. To meet this increasing demand for video content, advanced compression techniques such as High Efficiency Video Coding (HEVC) and Versatile Video Coding (VVC) have been developed, which efficiently compress video streams to make the transmission of high-quality videos feasible. However, it comes at a significant cost of increased energy consumption. The energy-hungry nature of video streaming has raised critical concerns, not only in terms of operational costs, but also concerning its environmental impact. Therefore, optimizing the energy consumption associated with the video streaming workflow becomes a pressing challenge for researchers and industry experts.

Video streaming relies primarily on HTTP Adaptive Streaming (HAS), a technique that divides videos into small segments, typically ranging from 2 seconds to 10 seconds in duration. Each segment is encoded in various bitrates and resolutions, referred to as a bitrate ladder. This approach ensures that each user receives the most appropriate representation based on their device's capabilities, such as a screen resolution and processing power, as well as prevailing network conditions. However, it is essential to note that providing multiple versions of the same content to accommodate adaptivity increases the energy demands of the video streaming workflow, which affects both encoding and decoding energy consumption.

Recent research efforts have been dedicated to enhancing the energy efficiency of the video encoding process, e.g., for HEVC or VVC. Numerous studies have explored ways to accelerate the encoding process by predicting the best coding modes or by introducing early skip or early termination methods. Alternatively, other approaches seek to simplify individual components of the codec, such as intra-mode decision, motion estimation, or transform component. There also has been introduced a recommended preset for each encoding, aiming to balance energy-efficient encoding and video quality.

However, decoding is more prevalent in Video on Demand (VOD) scenarios than in encoding. Within VOD platforms, videos are encoded once on the server and then repeatedly decoded on the client side during multiple viewings. Consequently, as the number of views (or impressions) increases, the significance of the decoding process becomes increasingly apparent. YouTube reported that the amount of videos encoded is only around 65×103 every day, while in the same period, there are about 108 videos decoded and views. Furthermore, it is reported that people, on average, spent about 17 hours per week watching online video content in 2023. Netflix recently disclosed that over six months, nearly 100 billion hours were views across more than 18,000 titles, accounting for 99% of all viewing on the platform. This massive demand for online video content underscores the crucial need to optimize the energy efficiency of decoding.

Existing approaches to optimizing video decoding energy consumption have focused primarily on simplifying the decoder components. For example, techniques include disabling the deblocking filter for the largest coding units and simplifying motion compensation by reducing Finite Impulse Response (FIR) filter sizes. An approach for implementing approximate computing in HEVC decoding has been explored, adjusting the interpolation filter of luma and chroma blocks based on an approximation level control parameter. An approach to define a skip control parameter to bypass deblocking and Sample Adaptive Offset (SAO) filters as needed for energy saving also has been explored. Another approach addressing motion compensation and deblocking filter operations has been proposed in the literature, where a complexity control method is proposed for non-salient areas to enhance subjective video quality. In still another study, the scalable extensions of HEVC are explored, presenting a method to disable a significant portion of deblocking filter and motion compensation operations in the base layer of the video.

Various studies have considered decoding energy consumption as the third variable within the Rate-Distortion (RD) optimization concept. These methods typically involve modeling decoder energy and selecting the coding mode that minimizes decoding energy consumption at the encoder side, with the cost of losing compression efficiency in terms of RD trade-offs. For instance, there are previous proposals of a decoder complexity model, along with modifying the cost function used in the RD optimization process. Similarly, others estimate the decoding energy consumption based on the encoding process and employ the Running Average Power Limit (RAPL) tool to measure the actual decoding energy. Still others have introduced a mathematical theory and developed a new optimization function at the encoder, considering the desired maximum bitrate and decoding energy. A tunable parameter to control the balance between bitrate and decoder energy consumption also has been introduced.

The aforementioned approaches primarily focus on optimizing either the encoding or decoding process for a single encoding. However, the opmitizaiont of video decoding within the context of videos streaming, where multiple encodings of the same content are involved, has not yet been addressed. For per-title encoding, the impact on energy is not considered, and only the quality is taken into account. Per-title encoding is a dynamic video compression technique that optimizes encoding parameters, such as resolution, for individual videos. This method selects encoding parameters that yield the highest quality at specific bitrates, enhancing the overall viewer experience. Therefore, an energy-aware spatial and temporal resolution selection for per-title encoding is desirable.

### BRIEF SUMMARY

A system and method are disclosed for energy-aware spatial and temporal resolution selection for per-title encoding. A method for energy-aware bitrate ladder construction for per-title encoding may include: receiving a set of spatial-temporal resolutions and an input video at an original resolution and framerate; downscaling the input video, thereby generating a set of downscaled versions of the input video at the set of spatial-temporal resolutions; encoding the set of downscaled versions using a set of input bitrates, thereby generating a set of video representations; decoding the set of video representations, there by generating a set of downscaled raw videos; upscaling the set of downscaled raw videos, thereby generating a processed video at the original resolution and framerate; evaluating a quality of the processed video using the input video as comparison, thereby generating a quality value for the processed video; and generating an energy-aware bitrate ladder using the quality value, an energy consumption value for a representation at each bitrate of the set of input bitrates, the set of input bitrates, and a tunable threshold value.

In some examples, the set of video representations, the set of downscaled raw videos, and the processed video comprise NBXNR instances. In some examples, the method also includes encoding the input video using the energy-aware bitrate ladder. In some examples, the energy consumption value is based on an amount of energy consumption during the decoding step. In some examples, the energy consumption value is based on an amount of energy consumption during the upscaling step. In some examples, generating the energy-aware bitrate ladder comprises selecting a highest-quality representation that satisfies the tunable threshold value. In some examples, the tunable threshold value comprises a maximum tolerable quality degradation.

A method for quality- and energy-aware resolution selection for per-title encoding may include: receiving a set of bitrates and an input video; selecting low complexity features of the input video, the low complexity features comprising a feature that can be extracted with low computational complexity; selecting a most relevant feature from the selected low complexity features; generating a candidate list of representations for each bitrate in the set of bitrates based on the most relevant feature, an input bitrate ladder, and a quality threshold value; selecting a representation from the candidate list of representations using an energy consumption lookup table and a tunable parameter, the look up table being configured to organize representations of the input video according to relative encoding and decoding energy consumption; and generating a quality- and energy-aware bitrate ladder using the selected representation.

In some examples, the method also may include encoding the input video using the quality- and energy-aware bitrate ladder. In some examples, the method also may include ranking the relative energy consumption for encoding and decoding each video resolution using the energy consumption lookup table. In some examples, selecting the low complexity features comprises employing Enhanced Video Complexity Analyzer (EVCA) to generate spatial and temporal complexity metrics, comprising one or a combination of spatial complexity, temporal complexity, spatial information, temporal information, and temporal energy. In some examples, the selecting the low complexity features comprises one, or a combination, of a logarithmic transformation, a power-of-two transformation, a feature-product transformation, and an exponential transformation. In some examples, the selecting the low complexity features comprises implementing a correlation-based feature selection algorithm. In some examples, the quality threshold value comprises a maximum tolerable quality degradation, the quality threshold value being used during a training phase of a candidate list prediction model. In some examples, a representation may be selected to be in the candidate list of representations if its difference in quality with a highest quality representation is below the quality threshold value. In some examples, the tunable parameter is predetermined based on a desired priority balance between reducing energy consumption and maintaining quality. In some examples, the tunable parameter comprises an integer value ranging from 1 to a maximum number of available representations.

A system for energy-aware bitrate ladder construction for per-title encoding may include: a memory comprising non-transitory computer-readable storage medium configured to store video data; one or more processors configured to execute instructions stored on the non-transitory computer-readable storage medium to: receive a set of spatial-temporal resolutions and an input video at an original resolution and framerate; downscale the input video, thereby generating a set of downscaled versions of the input video at the set of spatial-temporal resolutions; encode the set of downscaled versions using a set of input bitrates, thereby generating a set of video representations; decode the set of video representations, there by generating a set of downscaled raw videos; upscale the set of downscaled raw videos, thereby generating a processed video at the original resolution and framerate; evaluate a quality of the processed video using the input video as comparison, thereby generating a quality value for the processed video; and generate an energy-aware bitrate ladder using the quality value, an energy consumption value for a representation at each bitrate of the set of input bitrates, the set of input bitrates, and a tunable threshold value.

A system for quality- and energy-aware resolution selection for per-title encoding may include: a memory comprising non-transitory computer-readable storage medium configured to store video data; one or more processors configured to execute instructions stored on the non-transitory computer-readable storage medium to: receive a set of bitrates and an input video; select low complexity features of the input video, the low complexity features comprising a feature that can be extracted with low computational complexity; select a most relevant feature from the selected low complexity features; generate a candidate list of representations for each bitrate in the set of bitrates based on the most relevant feature, an input bitrate ladder, and a quality threshold value; select a representation from the candidate list of representations using an energy consumption lookup table and a tunable parameter, the look up table being configured to organize representations of the input video according to relative encoding and decoding energy consumption; and generate a quality- and energy-aware bitrate ladder using the selected representation.

### BRIEF DESCRIPTION OF THE DRAWINGS

Various non-limiting and non-exhaustive aspects and features of the present disclosure are described hereinbelow with references to the drawings, wherein:

FIG. 1A is a simplified block diagram illustrating a workflow for generating an energy-aware bitrate ladder using energy-aware spatial and temporal resolution selection (ESTR), in accordance with one or more embodiments.

FIG. 1B is a simplified block diagram illustrating a workflow for energy-aware per-title encoding using Live quality energy-aware spatial and temporal resolution selection (LiveESTR), in accordance with one or more embodiments.

FIG. 1C is a simplified block diagram illustrating a workflow for generating an energy-aware bitrate ladder using resolution selection based on video quality and decoding energy consumption, in accordance with one or more embodiments.

FIGS. 2A-2E are charts showing distributions of extracted complexity features from a LiveESTR method, in accordance with one or more embodiments.

FIG. 3 is a chart showing relative decoding energy consumption of a plurality of video resolutions at a given bitrate, in accordance with one or more embodiments.

FIGS. 4A-4L are charts showing rate quality curves and relative decoding energy consumption for exemplary video sequences using various ESTR techniques as compared to the prior art.

FIGS. 5A-5B are flow diagrams illustrating exemplary methods for energy efficient per-title encoding using ESTR and LiveESTR techniques, in accordance with one or more embodiments.

FIG. 6A is a simplified block diagram of an exemplary computing system configured to implement the workflows shown in FIGS. 1A-1B and to perform steps of the method illustrated in FIGS. 5A-5B, in accordance with one or more embodiments.

FIG. 6B is a simplified block diagram of an exemplary distributed computing system implemented by a plurality of the computing devices, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The invention is directed to energy-aware spatial and temporal resolution selection for per-title encoding, for example, considering decoding energy consumption during the construction of a bitrate ladder. This invention comprises an energy-aware spatial and temporal resolution (ESTR) selection for per-title encoding, designed to optimize both video quality and decoding energy consumption by selecting the most appropriate encoding parameters, such as spatial resolution and temporal resolution (framerate), for each bitrate. No changes to the implementations or configurations of the encoder or decoder are employed. The techniques described herein are easily applicable to existing streaming systems, balancing video compression efficiency and decoding energy consumption.

It is evident that decoding energy consumption significantly depends on both the spatial and temporal resolution of the video. This disparity offers an opportunity to optimize spatial and temporal resolution selection, not only by prioritizing quality, but also by considering energy efficiency. ESTR is designed to enhance energy efficiency in the streaming ecosystem without requiring modifications to the decoder or encoder implementations, making it compatible with existing streaming systems.

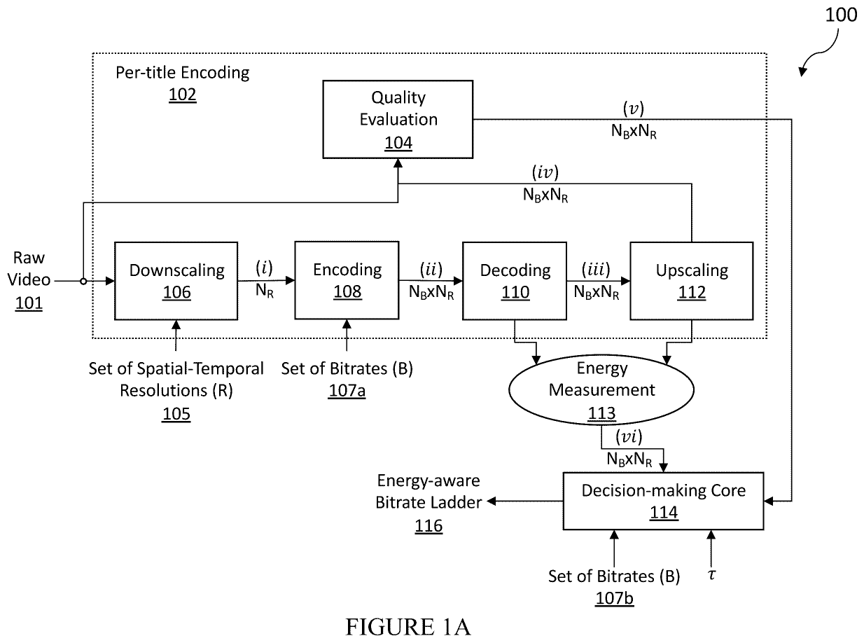

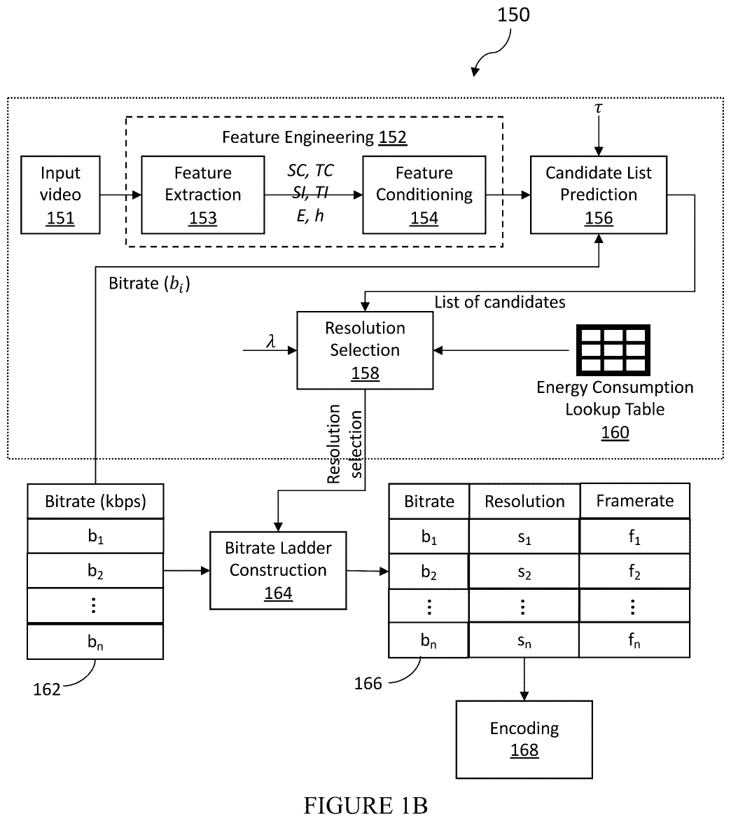

FIG. 1A is a simplified block diagram illustrating a workflow for generating an energy-aware bitrate ladder using energy-aware spatial and temporal resolution selection (ESTR), in accordance with one or more embodiments. An ESTR workflow 100 may comprise steps performed by elements of a basic per-title encoding system 102, including quality evaluation module 104, downscaling module 106, encoding module 108, decoding module 110, and upscaling module 112. The ESTR workflow also may include a decoding energy measurement element 113, a threshold t, and a core decision-making block (i.e., decision-making core 114).

For a given input video sequence (e.g., raw video 101) and a set of bitrates 107a, which may comprise steps in a bitrate ladder, the ESTR workflow may construct a decoding energy-aware bitrate ladder. Downscaling module 106 may receive (e.g., acquire) video 101 at its original resolution and framerate, along with a set of spatial-temporal resolutions 105. Downscaling module 106 may be configured to generate downscaled versions (i) of video 101 at the set of various framerates and resolutions 105. In some examples, downscaled versions (i) may comprise NR instances. An encoder (e.g., encoding module 108) may process said downscaled versions (i) using a set of input bitrates 107a, to generate video representations (ii), which may comprise NBXNR instances. Each representation of (ii) may be sent to a decoder (e.g., decoding module 110) to produce downscaled raw videos (iii), comprising NBXNR instances. The downscaled raw videos (iii) may be later upscaled by upscaling module 112 to restore them to their original spatial-temporal resolution, resulting in a processed video (iv) comprising NBXNR instances. A quality evaluation module 104 may evaluate the quality of the encoding of processed video (iv) by considering the input (i.e., raw) video 101 and the processed video (iv). An output (v) comprising a quality value representing the quality of the processed video and NBXNR instances may then be provided to decision-making core 114, along with a decoding energy consumption (vi) from decoding energy measurement element 113, set of bitrates 107b, and a tunable threshold t to construct an energy-aware bitrate ladder 116. In some examples, set of bitrates 107a and 107b may comprise the same input bitrate ladder.

In an example, a set of spatial resolutions, denoted as S={sᵢ|∈{0, 1, . . . , N_{S}−1}}, a set of temporal resolution (framerate), denoted as F=Fⱼ|j∈{0, 1, . . . , N_{F}−1}}, and the predefined bitrate values, denoted as B={bₖ|k∈{0, 1, . . . , N_{B}−1}}. In some examples, these bitrate values may form the bitrate ladder and depend on a service provider's choice and user requirements. For example, one might adopt HLS bitrate ladder values as a set of predefined bitrates and encode the videos accordingly. After a downscaling process (e.g., by downscaling module 106), the number of raw videos, referred to as NR, may be determined as follows:

$${N}_{R} = {N}_{S} \times {N}_{F}$$

As a result, a set of raw videos denoted as R={rₗ|l∈{0, 1, . . . , N_{R}−1}}, each of which is then encoded by encoding module 108, at some or all of the bitrates of the bitrate ladder 107a. This encoding generates N_{B}×N_{R} representations for each video sequence.

After decoding, upscaling, and quality measurement, each representation with a bitrate k and spatial-temporal resolution l will have a quality q_{k,l} relative to its original raw representation (e.g., from raw video input 101). In addition, each representation will have a value ek, indicating an amount of energy consumption during the decoding process. As described herein, quality q_{k,l} and energy consumption value e_{k,l} are measured after the temporal-spatial upscaling processes (e.g., performed by upscaling module 112). Therefore, the downscaled video is first upscaled to its original resolution and framerate before being compared to the original raw version (e.g., raw video 101). Additionally, the energy consumption includes both decoding and upscaling processes by decoding module 110 and upscaling module 112, respectively. Two sets Q and E, which include quality values and energy consumption values for all q_{k,l} and e_{k,l} may then be established, where k∈{0, 1, . . . , N_{B}−1} and l∈{0, 1, . . . , N_{R}−1}. Using sets Q and E, a highest-quality representation may be identified, and its quality difference compared to other representations at each bitrate (e.g., from set of bitrates 107a-107b).

In some examples, tunable quality parameter (i.e., threshold) τ serves as a tool for fine-tuning the trade-off between video compression efficiency and decoding energy consumption based on a service provider's considerations, offering flexibility in optimizing the energy efficiency of a video streaming workflow. The mechanism of this parameter operates such that if the video quality differences between the highest quality representation and one or more other representations at a given bitrate fall below the threshold, the representation with the lowest decoding energy consumption is selected to construct the bitrate ladder. Therefore, the higher the value of quality threshold τ, the more energy is saved per each decoding process. However, this energy savings comes at the cost of reduced compression efficiency. In some examples, τ may be a continuous value defined based on a chosen video quality metric. For example, if VMAF is the quality metric, the threshold unit t aligns with that of VMAF.

Given a defined threshold t and the measured sets Q and E, representations of the energy-aware bitrate ladder construction may be determined using Algorithm 1 below:

Algorithm 1 ESTR Bitrate Ladder Construction

| | |
|---|---|
| Data: | Set of qualities (Q), set of decoding energy con- |
| | sumption values (E), set of bitrates (B), set of |
| | spatial-temporal resolutions (R), quality threshold (τ) |

Result: Energy-aware bitrate ladder (EBL)
EBL ← Ø
for k=0 to N_{B} do

| \| | lₘₐₓ ← arg max(Q[k]) | | | |
|---|---|---|---|---|
| \| | selected ← lₘₐₓ | | | |
| \| | for l=0 to N_{R} do | | | |
| \| | \| | if ((Q[k][lₘₐₓ] − Q[k][l]) < τ) then | | |
| \| | \| | \| | if (E[k][l] < E[k][selected]) then | |
| \| | \| | \| | \|_{—} | selected ← l |

| | | |
|---|---|---|
| \| | \| | \|_{—} |

| | |
|---|---|
| \| | \|_{—} |
| \|_{—} | EBL.append((B[k], R[selected])) |

return EBL

In Algorithm 1, at each bitrate in set of bitrates (B), the representation that offers the highest quality is being identified and the quality difference for other video representations is being calculated. Among the candidate representations with quality differences below a threshold τ, a representation with the lowest decoding energy consumption may be selected. This iterative process may be carried out for every bitrate step, resulting in the creation of a set of representations constituting an energy-aware bitrate ladder EBL (e.g., energy-aware bitrate ladder 116). In Algorithm 1, an index selected may specify an index of a chosen representation for a given bitrate. If none of the representations meets the threshold t or its energy consumption is not lower than that of the highest quality representation, then selected index remains unchanged, retaining the index of the highest quality representation, which may be initialized for each bitrate.

FIG. 1B is a simplified block diagram illustrating a workflow for energy-aware per-title encoding using Live quality energy-aware spatial and temporal resolution selection (LiveESTR), in accordance with one or more embodiments. A LiveESTR workflow 150 may include resolution selection for each (i.e., a single) bitrate in an input bitrate ladder 162 (e.g., the resolution selection for each bitrate shown in the dotted box) to construct a quality- and energy-aware bitrate ladder (e.g., bitrate ladder 166) for encoding (e.g., per-title encoding). In some examples, a LiveESTR workflow 150 may predict the quality and energy consumption of an encoded video at each resolution. Rather than modeling this as a regression problem, which requires a large model with numerous influencing parameters and may result in significant errors, predicting relative values with a simplified model is sufficient to construct a quality- and energy-aware bitrate ladder (e.g., bitrate ladder 166). A simplified model may comprise identifying candidate resolutions that offer the best quality at each bitrate (e.g., of input bitrate ladder 162) for an input video sequence (e.g., input video 151). The simplified model also may comprise ranking the energy consumption for encoding and decoding each video resolution (e.g., using energy consumption lookup table 160). Based on the list of candidate resolutions from candidate list prediction 156 and the energy consumption rankings from lookup table 160, a resolution option may be selected that consumes the least energy from among the candidate resolutions.

In some examples, an input video 151 (e.g., a raw video, video sequence, etc.) may undergo feature engineering 152, candidate list prediction 156, and resolution selection 158. A set of features may be extracted from input video 151 by feature engineering module 152, the set of features then used to predict a list of candidate resolutions that provide a higher video quality based on quality threshold t for a given bitrate (e.g., by candidate list prediction module 156). Then a suitable resolution may be selected by resolution selection module 158 based on the candidate list, their respective decoding energy consumption, and a tunable parameter/(i.e., resolution selection parameter balancing video quality and energy savings). Selected resolutions at predefined bitrates may be collected by bitrate ladder construction module 164 to construct a quality- and energy-aware bitrate ladder. LiveESTR allows an encoder to avoid encoding all potential representations and to encode only the optimized ones that are needed for streaming.

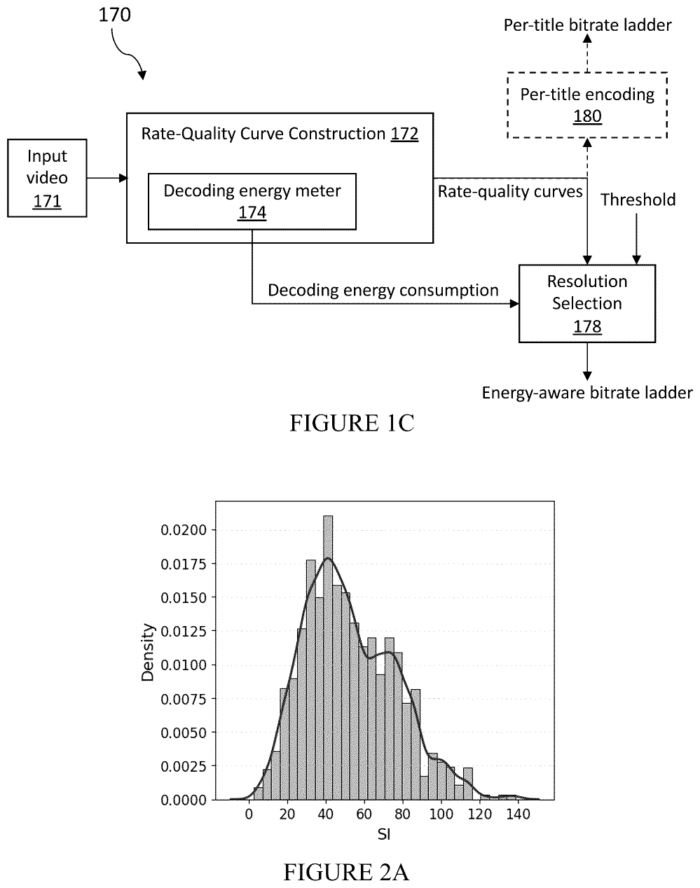

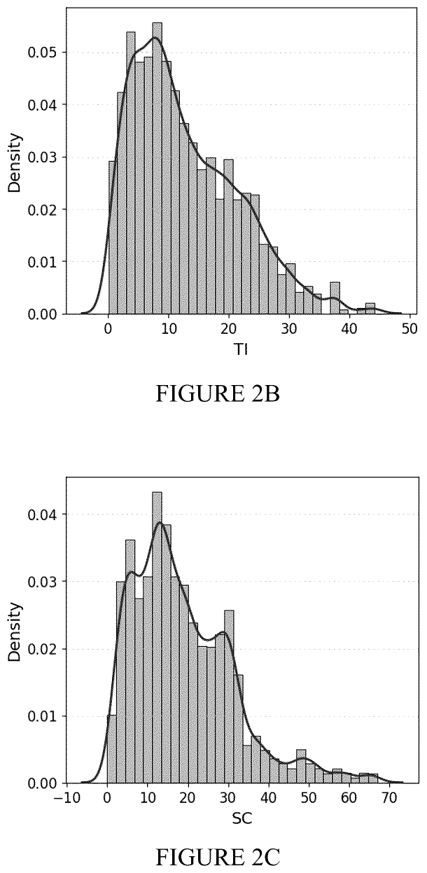

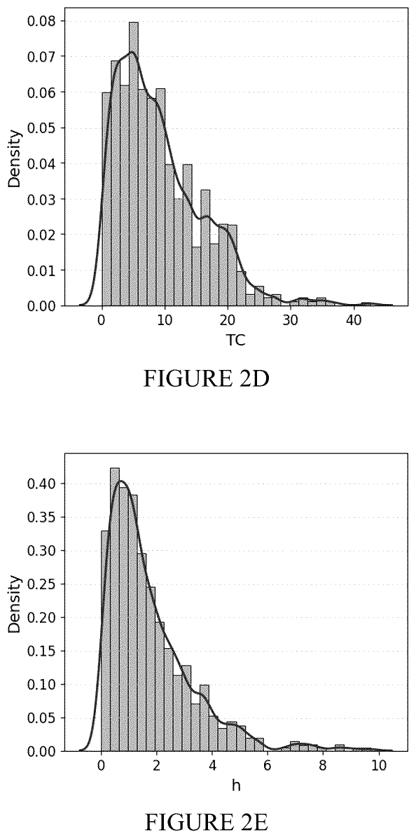

For live streaming applications, feature extraction module 153 may select features that can be extracted with low computational complexity (i.e., low complexity features). In some examples, Enhanced Video Complexity Analyzer (EVCA) may be used, which provides spatial and temporal complexity metrics, such as spatial complexity SC, temporal complexity TC, spatial information SI, temporal information TI, E, and temporal energy h. Employing a single tool for feature extraction may be more efficient by avoiding multiple read operations of uncompressed data from physical storage. In some examples, the metrics SC and E may be identical. Therefore, to reduce redundancy, E may be removed from the input feature set. To enhance prediction, in addition to the original features, combinations of features may also be considered for prediction. Logarithmic transformations may be included to cope with the feature skewness of SC, TC, TI, and h, as shown in the distributions in FIGS. 2A-2E. FIGS. 2A-2E are charts showing distributions of extracted complexity features from a LiveESTR method, in accordance with one or more embodiments, including distributions skewness of SI, TI, SC, TC, and h. Also, to capture non-linear relationships among features, transformations such as power-of-two and feature-product transformations may also be employed. Furthermore, exponential transformations may be used to amplify small differences in feature values, further enhancing prediction accuracy.

To reduce the number of input features, a correlation-based feature selection algorithm may be applied. This algorithm may calculate a correlation matrix of input features and remove one feature from any pair showing a high correlation of 0.95. A final input feature set may include all video complexity metrics, along with several transformations: logarithmic transformations of TI, SC, and TC; exponential transformations of SI, TI, and h; power-of-two transformations of TI, TC, and h; and feature products such as SI×TI and SC×h, which are listed in Table I, below.

TABLE I
LIST OF SELECTED FEATURES
AND THEIR TRANSFORMATIONS

| Features | Transformations |
|---|---|
| Spatial Information (SI) | e^{SI} |
| Temporal Information (TI) | log(TI), e^{TI}, TI² |
| Spatial Complexity (SC) | log(SC) |
| Temporal Complexity (TC) | log(TC), TC² |
| Temporal energy (h) | e^{h}, h² |
| Combinations | SI × TI, SC × h |

Feature conditioning module 154 may be configured to select and calculate the most relevant features.

In some examples, τ may comprise a threshold for the maximum tolerable quality degradation (e.g., an acceptable quality), ensuring that only representations meeting the acceptable quality criteria are selected during a training phase of the candidate list prediction. In some examples, τ may be any positive floating-point value starting from 0.0, depending on the quality metric. Any video representation that has a quality difference smaller than threshold τ, when compared to the highest quality achievable, may be considered a candidate by candidate list prediction module 156. In some examples, threshold τ may contribute to a training phase in specifying candidates, but not used as an input to the prediction model. For each video sequence and given bitrate, multiple resolutions may provide acceptable quality and qualify as a candidate, resulting in a list of candidates. A multi-label classification approach, wherein each of the labels corresponds to a given video resolution, may be used to estimate (i.e., predict) candidates for each video sequence and bitrate. A label may be used to represent whether a resolution is a candidate or not (e.g., 1 or 0, respectively). In modeling the regression problem of predicting video quality as a simpler multi-label classification task, faster and lighter models may be used to achieve a desired outcome efficiently. Thus, a chain of binary classifiers may be employed, where each classifier predicts a label for a given video resolution. Each classifier may take into account predictions of earlier classifiers in the chain.

In some examples, λ may be configured to guide the selection of a resolution index from the candidate list. In some examples, smaller values may prioritize the least energy-consuming resolutions. In some examples, λ may be an integer value, ranging from 1 to the maximum number of available representations.

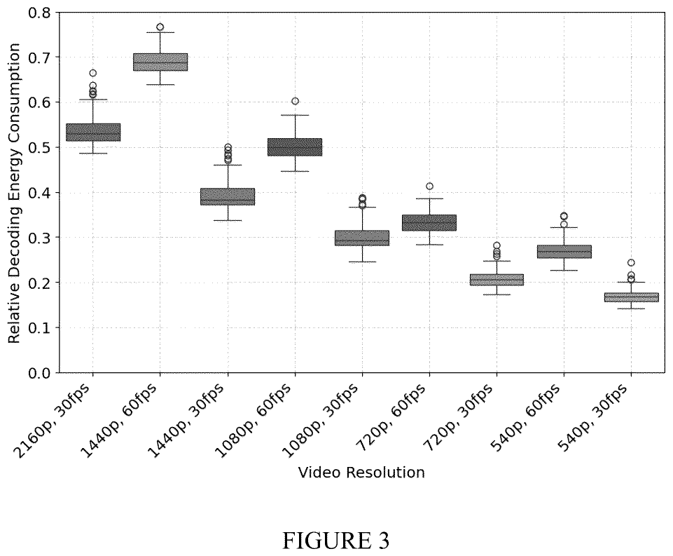

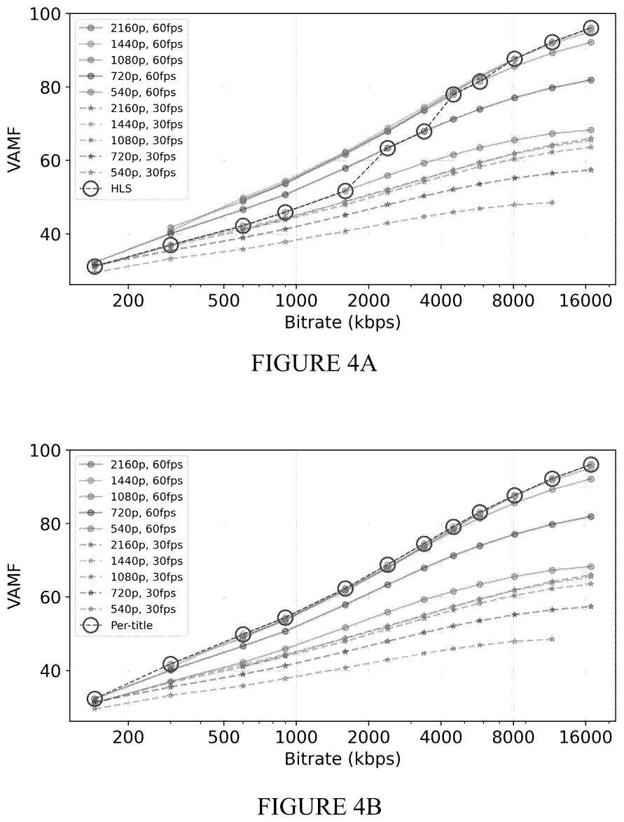

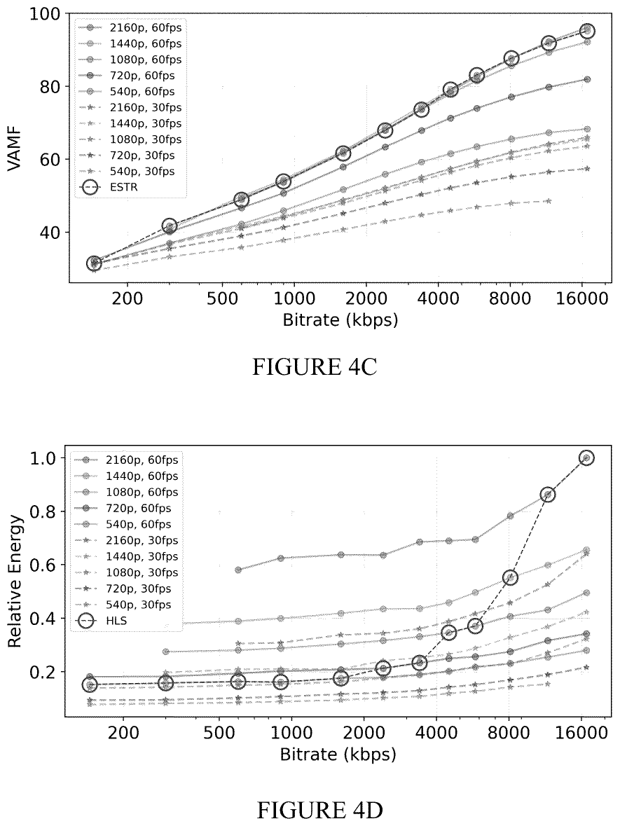

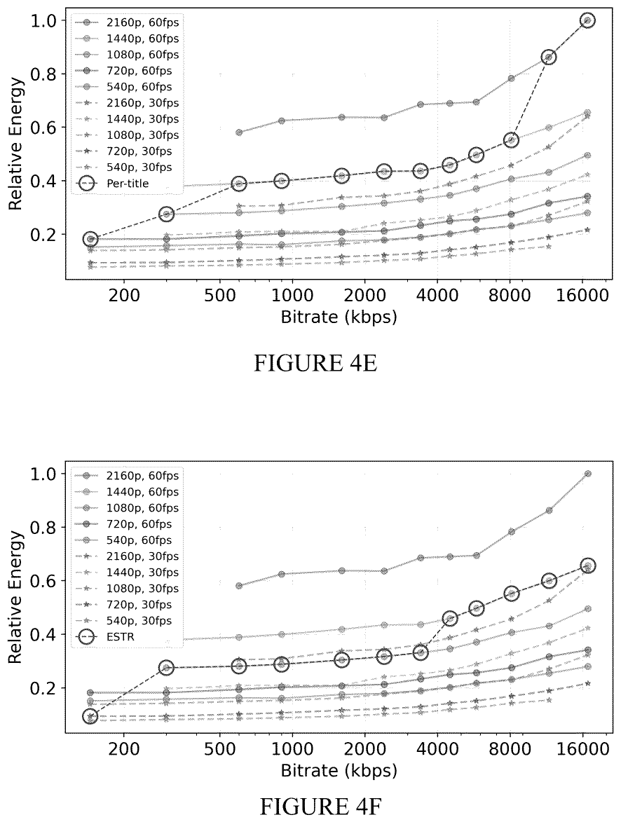

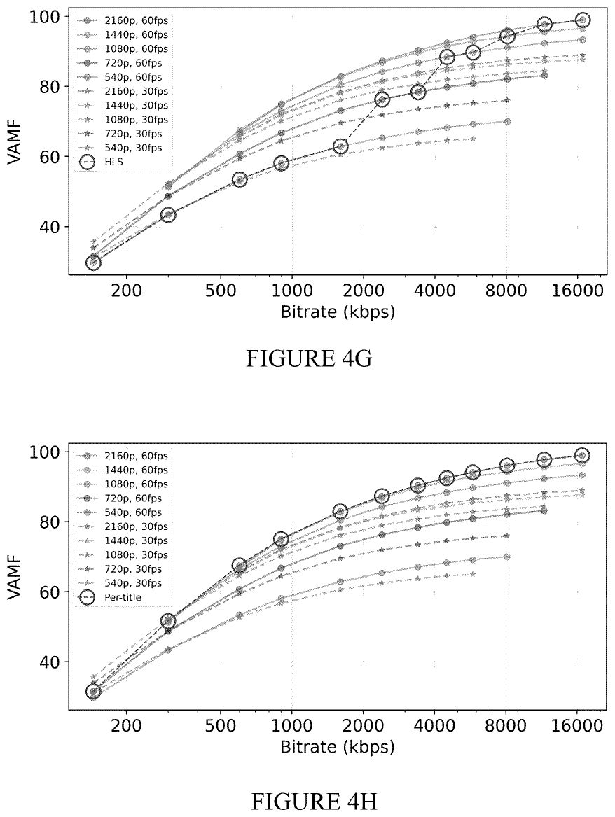

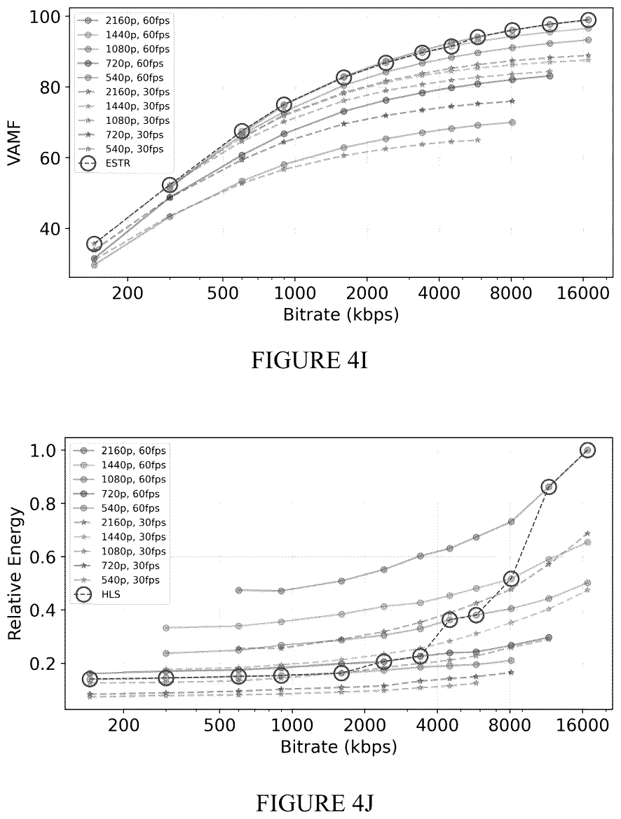

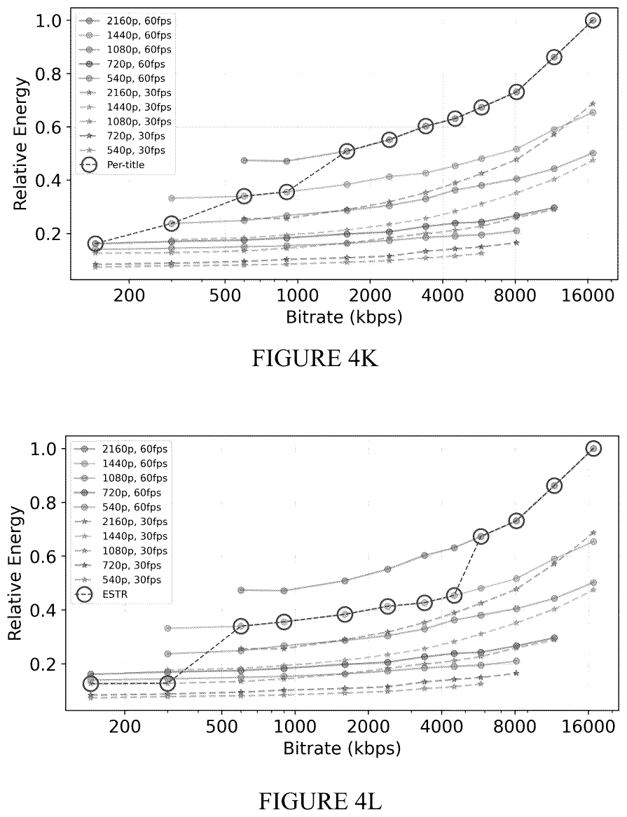

Decreasing spatial or temporal resolution may result in reducing energy consumption of a video encoder and decoder (e.g., less number of pixels are required to be processed). However, when downscaled versions are decoded, typically, an extra upscaling process to the original resolution is required on the decoder side. Consequently, energy consumption on the decoder side includes both decoder and upscaling processes, making it difficult to determine which method results in the least energy consumption: decoding at an original resolution or decoding at a lower resolution followed up upscaling to the original resolution. For advanced video codecs, the decoding energy is dominant compared to a simple upscaling method like bilinear, which is the default upscaling method in FFmpeg. For example, FIG. 3 is a chart showing relative decoding energy consumption of a plurality of video resolutions at a given bitrate, in accordance with one or more embodiments. Specifically, relative decoding energy consumption for each resolution at a bitrate of 1600 kbps is shown, normalized to energy consumption of 2160p at 60 fps. Downscaling the video to half the spatial resolution (e.g., 2160p to 1080p) may reduce the energy consumption by approximately half, as it requires an additional upscaling process during playback. Therefore, the encoding and decoding energy consumption of each representation E(r) may be approximately modeled using its resolution and framerate as follows:

$$E ( r ) = {S}_{r} \times {F}_{r}$$

where Sᵣ and Fᵣ represent a spatial and a temporal resolution (framerate) of the video representation, respectively. For example, for a video with a resolution of 2160p at 60 fps, Sᵣ=2160 and Fᵣ=60. While this does not provide an exact energy consumption for each video representation, it approximately ranks them, which is sufficient for selecting the representation with the lowest energy consumption. In some examples, energy consumption lookup table 160 (e.g., a fixed lookup table) may be employed as an easy, fast, effective approach. In some examples, energy consumption lookup table 160 may organize all available video resolutions in an order (e.g., ascending, descending) based on their E(r) values. A resolution in the first position may consume the least energy, while the one in the last position consumes the most energy for both encoding and decoding, or vice versa.

Resolution selection module 158 may be configured to retrieve or receive the candidate list from candidate list prediction 156 and corresponding energy consumption data (e.g., relative energy consumption based on E(r) values for the resolutions candidates in the candidate list) from lookup table 160. In some examples, resolution selection module 158 may be configured to sort the candidate list according to their relative energy consumption, e.g., in ascending order. A video representation maybe selected by resolution selection module 158 based on a tunable parameter λ, which may be defined to balance a trade-off between video quality and energy saving. Parameter λ may be configured to determine an index of representation that should be selected from the sorted candidate list.

For example, given a list R comprising a sorted collection of representations from lookup table 160, ordered by energy consumption from lowest to highest as follows:

$$R = \{ {r}_{1} , {r}_{2} , … , {r}_{m} \}$$

Where m comprises a number of candidate resolutions, wherein r₁ corresponds to the representation with the least energy consumption and rₘ corresponds to the representation with the highest energy consumption. In some examples, resolution selection module 158 may be configured to select r_{λ}. In this example, a higher value of λ indicates a preference for a lower energy saving and a higher video quality. The value of λ may be tuned (e.g., modified) to prioritize energy savings or improve quality. In some examples, if the candidate list is shorter than the λ value, a last element of the candidate list may be selected.

Resolution selection decisions from resolution selection module 158 may be gathered by bitrate ladder construction module 164 to form a set of pairs consisting of bitrate and spatial and temporal resolutions comprising quality- and energy-aware bitrate ladder 166. Encoding videos (e.g., input video 151) by an encoder (e.g., encoding module 168) using quality- and energy-aware bitrate ladder 166 reduces decoding energy consumption while keeping quality degradation below a desired threshold τ. A quality- and energy-aware bitrate ladder QEBL, as described herein, may be generated using Algorithm 2:

Algorithm 2: Live ESTR Method

| | Data: Input video (ν), set of bitrates (B), tunable | | | | |
|---|---|---|---|---|---|
| | parameter (λ), lookup table (LUT) | | | | |
| | Result: Quality- and energy-aware bitrate ladder | | | | |
| | (Q E B L) | | | | |
| 1 | Q E B L ← Ø | | | | |
| 2 | features ← feature_engineering(ν) | | | | |
| 3 | for b in B do | | | | |
| 4 | \| | c_list ← predict_candidate_list(b, features) | | | |
| | \| | pointer ← 1 | | | |
| 5 | \| | for rep in LUT do | | | |
| 6 | \| | \| | if rep in c_list then | | |
| 7 | \| | \| | \| | sel_rep ← rep | |
| 8 | \| | \| | \| | if pointer == λ then | |
| 9 | \| | \| | \| | \| | break |

| | | | | |
|---|---|---|---|---|
| 10 | \| | \| | \| | end |
| 11 | \| | \| | \| | pointer ← pointer + 1 |

| | | | |
|---|---|---|---|
| 12 | \| | \| | end |

| | | |
|---|---|---|
| 13 | \| | end |
| 14 | \| | Q E B L.append((b, sel_rep)) |

| | |
|---|---|
| 15 | end |
| 16 | return Q E B L |

In Algorithm 2, variable c_list may temporarily store a candidate list of resolutions (e.g., from candidate list prediction 156). Loop variable rep may iterate over the lookup table representations (e.g., from lookup table 160), while sel_rep may hold the most recently selected video resolutions. In some examples, when the pointer reaches the value of λ, sel_rep will then contain the desired resolution. As described herein, inputs to Algorithm 2 may include an input video (v), set of bitrates (B), tunable parameter (λ), and lookup table (LUT); outputs may include a quality- and energy-aware bitrate ladder (QEBL).

FIG. 1C is a simplified block diagram illustrating a workflow for generating an energy-aware bitrate ladder using resolution selection based on video quality and decoding energy consumption, in accordance with one or more embodiments. In this alternative workflow 170, video quality and decoding energy consumption is optimized in selecting a most suitable resolution for each bitrate, thereby generating (e.g., constructing) an energy-aware bitrate ladder, similar to those described herein. In workflow 170, rate-quality curve construction module 172 may be configured to construct rate-quality curves for all video resolutions of input video 171. Decoding energy meter 174 may be configured to measure decoding energy consumption for all bitrate-resolution pairs. The decoding energy consumption information may be provided to resolution selection module 178. Resolution selection module 178 may be configured to receive rate-quality curves data, decoding energy consumption data, and a threshold (e.g., given by a service provider), to construct an energy-aware bitrate ladder. In some examples, the threshold may be the same or similar to other quality thresholds (e.g., τ) described herein. In some examples, the rate-quality curves data also may be provided to per-title encoding module 180 to generate a per-title bitrate ladder.

In an example, given a set of resolutions S={s₁, s₂, . . . , s_{|S|}}, and a set of bitrate values B={b₁, b₂, . . . , b_{|B|}}, each encoding configuration, represented as r_{i,j} may be defined as follows:

$${r}_{i , j} = ( {q}_{i , j} , {e}_{i , j} )$$

Here, q_{i,j} and e_{i,j} correspond to the quality and decoding energy consumption associated with bitrate (i) and resolution (j). A set R may be defined to encompass all possible combinations of bitrate-resolution pairs from sets S and B as follows:

$$R = \{ {r}_{i , j} \vert i ∈ B , j ∈ S \}$$

Having the R values at hand, it becomes possible to calculate a highest-quality representation and its quality difference compared to other representations at each bitrate. Also, by using a predefined threshold, representations with quality differences below the threshold may be identified as potential selection candidates, creating a potential candidate pool. From this pool of candidates, resolution selection module 178 may be configured to select a representation that minimizes decoding energy consumption, and to use the selected representation to construct an energy-aware bitrate ladder. An array of selected representations for the energy-aware bitrate ladder may be generated using Algorithm 3:

Algorithm 3: Energy-aware Bitrate Ladder Construction

Input: Quality threshold (Thr), representations (R)
Output: Array of selected representations (L)
cnt ← 0
for i in B do

| \| | highestQ ← arg max(R[i]) | | |
|---|---|---|---|
| \| | selected ← R[i][highestQ] | | |
| \| | for j in S do | | |
| \| | \| | current ← R[i][j] | |
| \| | \| | qualityDiff ← R[i][highestQ] − current | |
| \| | \| | if (qualityDiff < Thr) and | |
| \| | \| | (current.energy < selected.energy) then | |
| \| | \| | \| | selected ← current |
| \| | \| | \| | index ← (i, j) |

| | | |
|---|---|---|
| \| | \| | \|_{—} |

| | |
|---|---|
| \| | \|_{—} |
| \| | L[cnt] ← index |
| \| | cnt ← cnt + 1 |

|_{—}
return L

### Example Methods

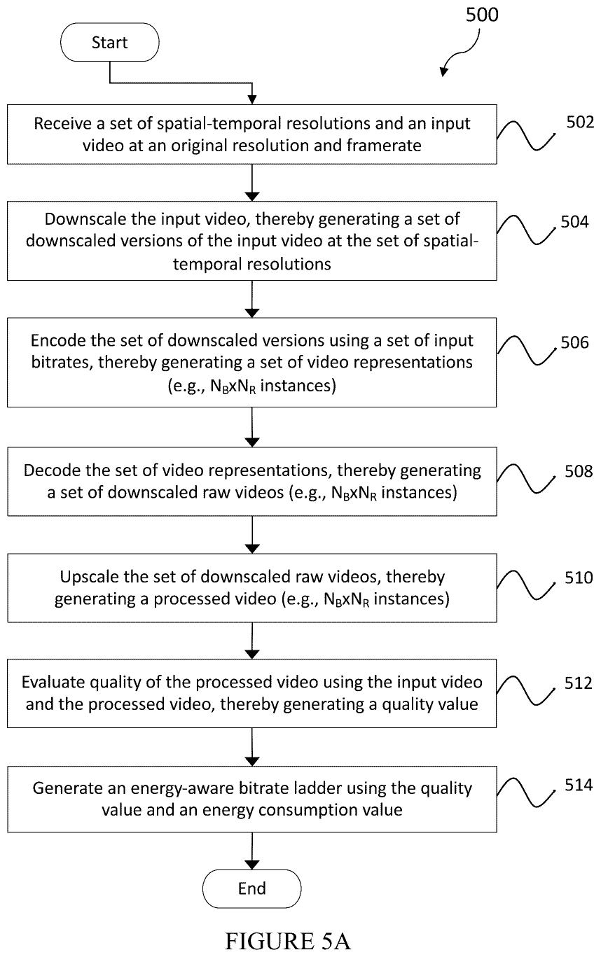

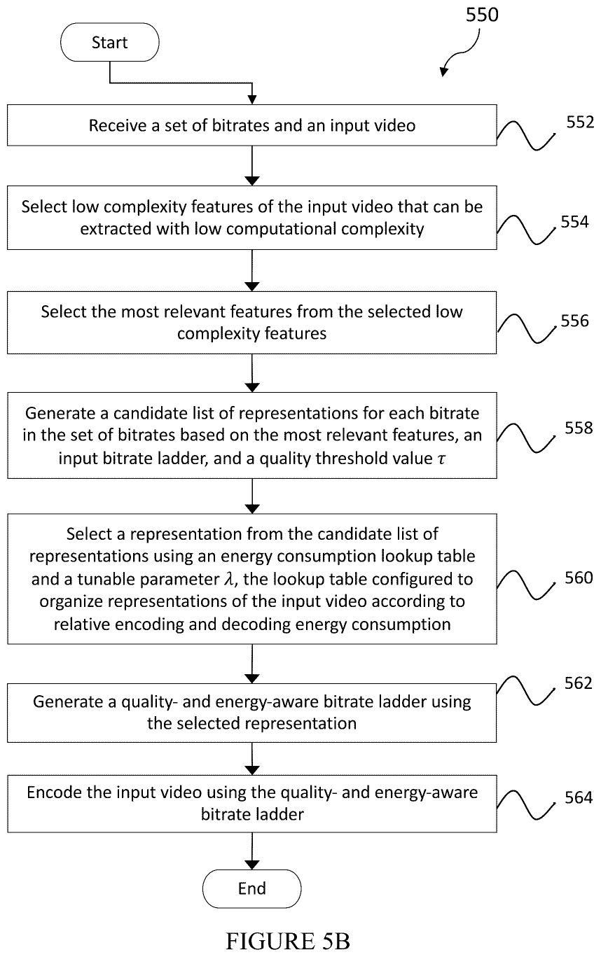

FIGS. 5A-5B are flow diagrams illustrating exemplary methods for energy efficient per-title encoding using ESTR and LiveESTR techniques, in accordance with one or more embodiments. Method 500 may begin with receiving a set of spatial-temporal resolutions and an input video at an original resolution and framerate at step 502. The input video may be downscaled at step 504, thereby generating a set of downscaled versions of the input video at the set of spatial-temporal resolutions, respectively. The set of downscaled versions may be encoded using a set of input bitrates at step 506, thereby generating a set of video representations. As described above, an encoder may generate N_{B}×N_{R} instances of the video representations. The set of video representations may then be decoded at step 508, thereby generating a set of downscaled raw videos (e.g., again N_{B}×N_{R} instances). The set of downscaled raw videos may then be upscaled (e.g., to the original resolution and framerate) at step 510, thereby generating a processed video (e.g., also N_{B}×N_{R} instances), the processed video being upscaled to the original resolution and framerate. The quality of the processed video may be evaluated (e.g., by a quality evaluation module, as described herein) using the input video and the processed video at step 512, thereby generating a quality value. An energy-aware bitrate ladder (EBL) may be generated using the quality value and an energy consumption value at step 514. In some examples, the energy-aware bitrate ladder also may be based on a set of input bitrates and a tunable threshold value τ.

In FIG. 5B, method 550 may begin with receiving a set of bitrates and an input video at step 552. Low complexity features for the input video may be selected at step 554, the low complexity features being ones that can be extracted with low computational complexity. The most relevant features may be selected from the selected low complexity features at step 556. A candidate list of representations for each bitrate in the set of bitrates may be generated based on the most relevant features, an input bitrate ladder, and a quality threshold value t at step 558. In some examples, as described above, quality threshold value t may be used during a training phase for a candidate list prediction module. A representation may be selected from the candidate list of representations using an energy consumption lookup table and a tunable parameter 1 at step 560, the lookup table configured to organize representations of the input video according to relative encoding and decoding energy consumption. A quality- and energy-aware bitrate ladder (QEBL) may be generated using the selected representation at step 562. The QEBL may comprise a selected representation for each bitrate in the set of bitrates. The input video may be encoded at step 564 using the QEBL.

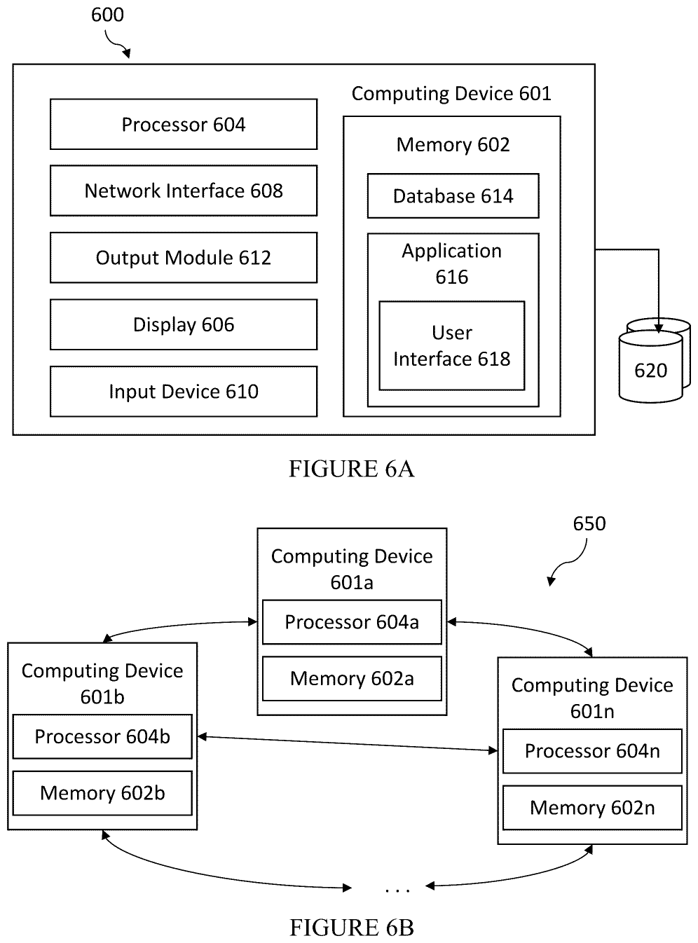

FIG. 6A is a simplified block diagram of an exemplary computing system configured to implement the workflows shown in FIGS. 1A-1B and to perform steps of the method illustrated in FIGS. 5A-5B, in accordance with one or more embodiments. In one embodiment, computing system 600 may include computing device 601 and storage system 620. Storage system 620 may comprise a plurality of repositories and/or other forms of data storage, and it also may be in communication with computing device 601. In another embodiment, storage system 620, which may comprise a plurality of repositories, may be housed in one or more of computing device 601. In some examples, storage system 620 may store video data, bitrate ladders, instructions, programs, and other various types of information as described herein. This information may be retrieved or otherwise accessed by one or more computing devices, such as computing device 601, in order to perform some or all of the features described herein. Storage system 620 may comprise any type of computer storage, such as a hard-drive, memory card, ROM, RAM, DVD, CD-ROM, write-capable, and read-only memories. In addition, storage system 620 may include a distributed storage system where data is stored on a plurality of different storage devices, which may be physically located at the same or different geographic locations (e.g., in a distributed computing system such as system 650 in FIG. 6B). Storage system 620 may be networked to computing device 601 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 601 also may include a memory 602. Memory 602 may comprise a storage system configured to store a database 614 and an application 616. Application 616 may include instructions which, when executed by a processor 604, cause computing device 601 to perform various steps and/or functions, as described herein. Application 616 further includes instructions for generating a user interface 618 (e.g., graphical user interface (GUI)). Database 614 may store various algorithms and/or data, including neural networks (e.g., video encoding, predicting resolution candidates, modeling relative encoding and/or decoding energy consumption, etc.) and data regarding bitrates, framerates, encoding and/or decoding energy consumption, predetermined and/or tunable thresholds and parameters, among other types of data. Memory 602 may include any non-transitory computer-readable storage medium for storing data and/or software that is executable by processor 604, and/or any other medium which may be used to store information that may be accessed by processor 604 to control the operation of computing device 601.

Computing device 601 may further include a display 606, a network interface 608, an input device 610, and/or an output module 612. Display 606 may be any display device by means of which computing device 601 may output and/or display data. Network interface 608 may be configured to connect to a network using any of the wired and wireless short range communication protocols described above, as well as a cellular data network, a satellite network, free space optical network and/or the Internet. Input device 610 may be a mouse, keyboard, touch screen, voice interface, and/or any or other hand-held controller or device or interface by means of which a user may interact with computing device 601. Output module 612 may be a bus, port, and/or other interface by means of which computing device 601 may connect to and/or output data to other devices and/or peripherals.

In one embodiment, computing device 601 is a data center or other control facility (e.g., configured to run a distributed computing system as described herein), and may communicate with a media playback device. As described herein, system 600, and particularly computing device 601, may be used for encoding video, downscaling video, upscaling video, optimizing and constructing a bitrate ladder, calculating objective metrics, and otherwise implementing steps in quality- and/or energy-aware resolution selection for per-title encoding, as described herein. Various configurations of system 600 are envisioned, and various steps and/or functions of the processes described herein may be shared among the various devices of system 800 or may be assigned to specific devices.

FIG. 6B is a simplified block diagram of an exemplary distributed computing system implemented by a plurality of the computing devices, in accordance with one or more embodiments. System 650 may comprise two or more computing devices 601a-n. In some examples, each of 601a-n may comprise one or more of processors 604a-n, respectively, and one or more of memory 602a-n, respectively. Processors 604a-n may function similarly to processor 604 in FIG. 6A, as described above. Memory 602a-n may function similarly to memory 602 in FIG. 6A, as described above.

While specific examples have been provided above, it is understood that the present invention can be applied with a wide variety of inputs, thresholds, ranges, and other factors, depending on the application. For example, the time frames, rates, ratios, and ranges provided above are illustrative, but one of ordinary skill in the art would understand that these time frames and ranges may be varied or even be dynamic and variable, depending on the implementation.

As those skilled in the art will understand a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A method for energy-aware bitrate ladder construction for per-title encoding comprising:
receiving a set of spatial-temporal resolutions and an input video at an original resolution and framerate;
downscaling the input video, thereby generating a set of downscaled versions of the input video at the set of spatial-temporal resolutions;
encoding the set of downscaled versions using a set of input bitrates, thereby generating a set of video representations;
decoding the set of video representations, there by generating a set of downscaled raw videos;
upscaling the set of downscaled raw videos, thereby generating a processed video at the original resolution and framerate;
evaluating a quality of the processed video using the input video as comparison, thereby generating a quality value for the processed video; and
generating an energy-aware bitrate ladder using the quality value, an energy consumption value for a representation at each bitrate of the set of input bitrates, the set of input bitrates, and a tunable threshold value.

2. The method of claim 1, wherein the set of video representations, the set of downscaled raw videos, and the processed video comprise N_{B}×N_{R} instances.

3. The method of claim 1, further comprising encoding the input video using the energy-aware bitrate ladder.

4. The method of claim 1, wherein the energy consumption value is based on an amount of energy consumption during the decoding step.

5. The method of claim 1, wherein the energy consumption value is based on an amount of energy consumption during the upscaling step.

6. The method of claim 1, wherein generating the energy-aware bitrate ladder comprises selecting a highest-quality representation that satisfies the tunable threshold value.

7. The method of claim 1, wherein the tunable threshold value comprises a maximum tolerable quality degradation.

8. A method for quality- and energy-aware resolution selection for per-title encoding comprising:
receiving a set of bitrates and an input video;
selecting low complexity features of the input video, the low complexity features comprising a feature that can be extracted with low computational complexity;
selecting a most relevant feature from the selected low complexity features;
generating a candidate list of representations for each bitrate in the set of bitrates based on the most relevant feature, an input bitrate ladder, and a quality threshold value;
selecting a representation from the candidate list of representations using an energy consumption lookup table and a tunable parameter, the look up table being configured to organize representations of the input video according to relative encoding and decoding energy consumption; and
generating a quality- and energy-aware bitrate ladder using the selected representation.

9. The method of claim 8, further comprising encoding the input video using the quality- and energy-aware bitrate ladder.

10. The method of claim 8, further comprising ranking the relative energy consumption for encoding and decoding each video resolution using the energy consumption lookup table.

11. The method of claim 8, wherein selecting the low complexity features comprises employing Enhanced Video Complexity Analyzer (EVCA) to generate spatial and temporal complexity metrics, comprising one or a combination of spatial complexity, temporal complexity, spatial information, temporal information, and temporal energy.

12. The method of claim 8, wherein the selecting the low complexity features comprises one, or a combination, of a logarithmic transformation, a power-of-two transformation, a feature-product transformation, and an exponential transformation.

13. The method of claim 8, wherein the selecting the low complexity features comprises implementing a correlation-based feature selection algorithm.

14. The method of claim 8, wherein the quality threshold value comprises a maximum tolerable quality degradation, the quality threshold value being used during a training phase of a candidate list prediction model.

15. The method of claim 8, wherein a representation may be selected to be in the candidate list of representations if its difference in quality with a highest quality representation is below the quality threshold value.

16. The method of claim 8, wherein the tunable parameter is predetermined based on a desired priority balance between reducing energy consumption and maintaining quality.

17. The method of claim 8, wherein the tunable parameter comprises an integer value ranging from 1 to a maximum number of available representations.

18. A system for energy-aware bitrate ladder construction for per-title encoding comprising:
a memory comprising non-transitory computer-readable storage medium configured to store video data;
one or more processors configured to execute instructions stored on the non-transitory computer-readable storage medium to:
receive a set of spatial-temporal resolutions and an input video at an original resolution and framerate;
downscale the input video, thereby generating a set of downscaled versions of the input video at the set of spatial-temporal resolutions;
encode the set of downscaled versions using a set of input bitrates, thereby generating a set of video representations;
decode the set of video representations, there by generating a set of downscaled raw videos;
upscale the set of downscaled raw videos, thereby generating a processed video at the original resolution and framerate;
evaluate a quality of the processed video using the input video as comparison, thereby generating a quality value for the processed video; and
generate an energy-aware bitrate ladder using the quality value, an energy consumption value for a representation at each bitrate of the set of input bitrates, the set of input bitrates, and a tunable threshold value.

19. A system for quality- and energy-aware resolution selection for per-title encoding comprising:
a memory comprising non-transitory computer-readable storage medium configured to store video data;
one or more processors configured to execute instructions stored on the non-transitory computer-readable storage medium to:
receive a set of bitrates and an input video;
select low complexity features of the input video, the low complexity features comprising a feature that can be extracted with low computational complexity;
select a most relevant feature from the selected low complexity features;
generate a candidate list of representations for each bitrate in the set of bitrates based on the most relevant feature, an input bitrate ladder, and a quality threshold value;
select a representation from the candidate list of representations using an energy consumption lookup table and a tunable parameter, the look up table being configured to organize representations of the input video according to relative encoding and decoding energy consumption; and
generate a quality- and energy-aware bitrate ladder using the selected representation.
